(19) United States
(12) Patent Application Publication
(10) Pub. No.: US 2020/0154674 A1
(43) Pub. Date: May 21, 2020

(54) Ultimate Kat Toy

(71) Applicant: Gregory Mandric Cosey, San Pedro, CA (US)

(72) Inventors: Gregory Mandric Cosey, San Padro, CA (US); Thomas Cole, JR., San Padro, CA (US)

(21) Appl. No.: 16/272,745

(22) Filed: Feb. 11, 2019

Related U.S. Application Data
(60) Provisional application No. 62/639,050, filed on Mar. 6, 2018.

(51) Int. Cl. A01K 15/02

(52) U.S. Cl. CPC A01K 15/025; A01K 15/027

(57) ABSTRACT

The present disclosure is directed towards an animal entertainment apparatus. The apparatus includes a wire element and a moveable base configured to move about the wire element in a first direction towards the first end and in a second directions towards the second end. The wire element includes a first end and a second end. The second end is located at an opposing end from the first end. The moveable base includes an outer housing, which includes at least two mating pieces. The moveable base includes a motor configured to power the moveable base to traverse the wire element.

### FIELD OF THE INVENTION

The present disclosure generally relates to an electronic device configured to entertain domestic pets. Specifically, the present disclosure relates to a device configured to move in more than one direction along a wire for the entertainment of a feline pet.

### BACKGROUND OF THE DISCLOSURE

A wide variety of pet toys are known. Cat play and toys incorporates predatory games of “play aggression”. Cats' behaviors when playing are similar to hunting behaviors. These activities allow kittens and younger cats to grow and acquire cognitive and motor skills, and to socialize with other cats. Cat play behavior can be either solitary (with toys or other objects) or social (with animals and people). They can play with a multitude of toys ranging from strings, to small furry toys resembling what would be prey (e.g. mice), to plastic bags.

Object play for animals (in this case, cats) is the use of inanimate objects by the animal to express play behaviour. In the case of pet domestic cats, humans normally provide them with purchased, human-made toys such as toy mice. When it comes to non-domestic, wild cats, they may use several objects in the wilderness as their toys including sticks, leaves, rocks, feathers, etc. Actions that cats may carry out as this play behaviour include throwing the toy object, chasing, biting, capturing, etc. as they might do with a real source of prey. Engaging in object play helps young cats to practice these skills that they need as they grow into adults.

### SUMMARY OF THE DISCLOSURE

The present disclosure is directed towards an animal entertainment apparatus. The apparatus includes a wire element and a moveable base configured to move about the wire element in a first direction towards the first end and in a second directions towards the second end. The wire element includes a first end and a second end. The second end is located at an opposing end from the first end. The moveable base includes an outer housing, which includes at least two mating pieces. The moveable base includes a motor configured to power the moveable base to traverse the wire element.

In some embodiments, the motor includes at least one pulley wheel configured to receive the wire element. The moveable base includes two riding pulley wheels in addition to the pulley wheel attached to the motor. In some embodiments, a first mating piece of the at least two mating pieces includes a receiving aperture. The second mating piece includes a threaded receiving element configured to receive a securing device partially extending through the receiving aperture.

In some embodiments, one of the mating pieces includes light-emitting diodes (LEDs). In some embodiments, one of the mating pieces includes a motor housing and a venting slot. In some embodiments, the animal entertainment apparatus includes a dropline device configured to extend from the moveable base. The dropline device includes an attaching lure at an opposing end from the moveable base. The animal entertainment apparatus can also include a remote control device configured to send commands in the form of infrared signals.

In some embodiments, the moveable base includes a receiver element configured to receive commands from the remote control device. In some embodiments, the moveable base includes a payload configured to house the receiver element. In some embodiments, the first end of the wire element is between 10 and 20 feet from the second end of the wire element.

The present disclosure is also directed towards a moveable base configured to move about a wire element in a first direction towards a first end of the wire element and in a second directions towards a second end of the wire element. The moveable base includes an outer housing, which includes at least two mating pieces. A first mating piece of the mating pieces includes at least one receiving aperture. A second mating piece includes a threaded receiving element configured to receive a securing device partially extending through the receiving aperture. The moveable base also includes a motor located within a motor housing of one of the at least two mating pieces. The motor is configured to power the moveable base to traverse the wire element. The moveable base also includes a receiver element configured to receive commands from the remote control device.

In some embodiments, the motor includes a pulley wheel configured to receive the wire element. In some embodiments, one of the mating pieces includes light-emitting diodes (LEDs). In some embodiments, one of the mating pieces includes a venting slot for the motor. In some embodiments, wherein the moveable base includes a payload configured to house the receiver element. In some embodiments, the moveable base includes a dropline device configured to extend from the payload. The dropline device includes an attaching lure at an opposing end from the payload.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 illustrates an exemplary moveable base, in accordance with an embodiment of the present disclosure; and

FIG. 2 illustrates an animal entertainment apparatus incorporating the exemplary moveable base of FIG. 1, in accordance with an embodiment of the present disclosure.

### DETAILED DESCRIPTION OF THE DISCLOSURE

The present invention is described with reference to the attached figures, where like reference numerals are used throughout the figures to designate similar or equivalent elements. The figures are not drawn to scale, and they are provided merely to illustrate an instant embodiment. Several embodiments are described below with reference to example applications for illustration. It should be understood that numerous specific details, relationships, and methods are set forth to provide a full understanding of the disclosure. One having ordinary skill in the relevant art, however, will readily recognize that the disclosed embodiments can be practiced without one or more of the specific details, or with other methods. In other instances, well-known structures or operations are not shown in detail to avoid obscuring the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Some features disclosed herein are defined using directional terminology, such as proximal and distal. For the purposes of this discussion, the distal end is the end that is positioned away from the operator. In contrast, the proximal end is the end that is closest to the operator. It should be understood that the novelties and features claimed herein are not confined to any particular position, unless otherwise stated. Therefore, the disclosed configuration and associated methods of use can be used in any direction or orientation in accordance with the disclosed embodiments.

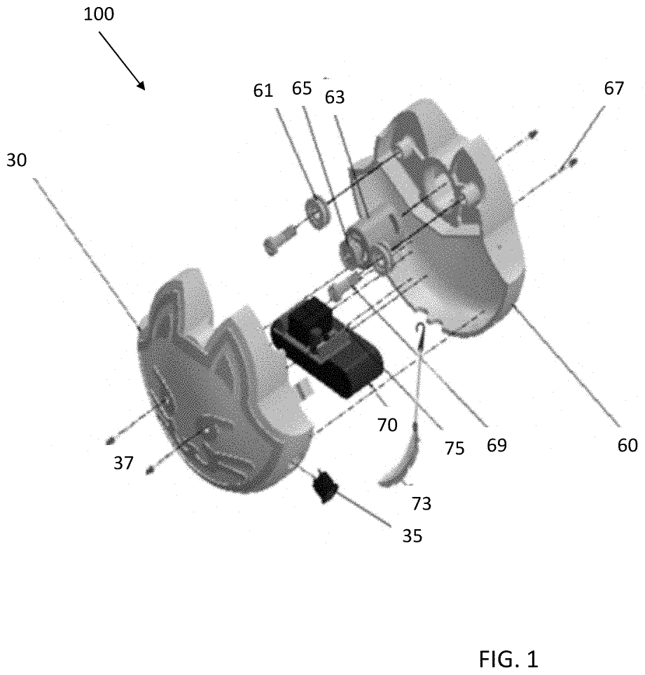

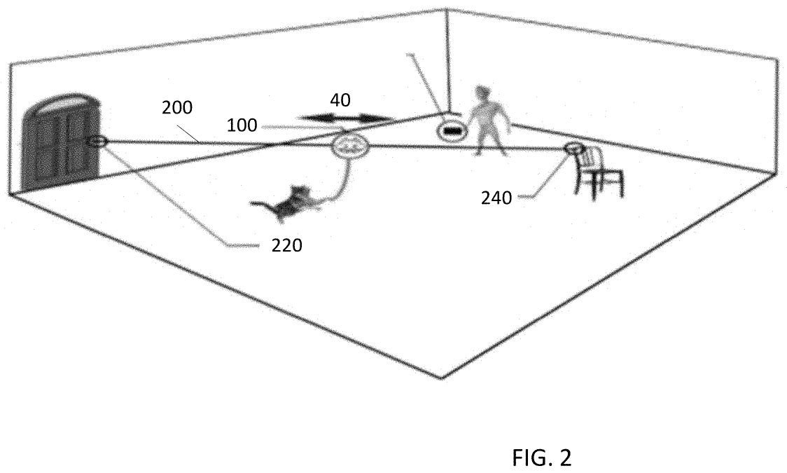

FIG. 1 illustrates an exemplary moveable base 100, in accordance with an embodiment of the present disclosure. The moveable base 100 is configured to move about a wire element (shown in FIG. 2). The moveable base 100 includes an outer housing, which includes two mating pieces 30 and 60. The first mating piece 30 can include at least one receiving aperture 37. The second mating piece 60 includes a threaded receiving element configured to receive a securing device 69 partially extending through the receiving aperture 37. The moveable base 100 also includes a motor 63 located within a motor housing of the second mating piece 60. The motor 63 is configured to power the moveable base 100 to traverse the wire element (shown in FIG. 2). The moveable base 100 also includes a receiver element 75 configured to receive commands from a remote control device (not shown).

In some embodiments, the motor 63 includes a pulley wheel 65 configured to receive the wire element. The moveable base 100 also includes two riding pulley wheels in addition to the pulley wheel 65 attached to the motor 63. In some embodiments, the first mating piece 30 includes a light-emitting diodes (LED) 35. In some embodiments, either of the mating pieces can include a venting slot (not shown) for the motor 63. In some embodiments, the moveable base 100 includes a payload 70 configured to house the receiver element 75. In some embodiments, the moveable base 100 includes a dropline device 73 configured to extend from the payload 70. The dropline device 75 includes an attaching lure at an opposing end from the payload 70. In some embodiments, the attaching lure can include a feather, or any other type of visually attractive element.

FIG. 2 illustrates an animal entertainment apparatus incorporating the exemplary moveable base 100 of FIG. 1, in accordance with an embodiment of the present disclosure. The apparatus can include a wire element 200 and a moveable base 100 configured to move about the wire element 200. The wire element 200 can include a string, or a metallic mesh fabric. The wire element 200 can include a first end 220 and a second end 240. The moveable base 100 can move about the wire element 200 in directions 40 towards the first end 220 and towards the second end 240. The wire element 200 includes. The second end 240 is located at an opposing end from the first end 220. As indicated above, the moveable base 100 can include a motor (not shown) configured to power the moveable base 100 to traverse the wire element 200. In some embodiments, the first end 220 of the wire element 200 is between 10 and 20 feet from the second end 240 of the wire element 200. The first end 220 can be attached to a door handle. The second end 240 can be attached to a chair, or any other structure. It should be understood, the examples illustrated herein are for exemplary purposes only.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s).

The foregoing description of various embodiments of the invention known to the applicant at this time of filing the application has been presented and is intended for the purposes of illustration and description. The present description is not intended to be exhaustive nor limit the invention to the precise form disclosed and many modifications and variations are possible in the light of the above teachings. The embodiments described serve to explain the principles of the invention and its practical application and to enable others skilled in the art to utilize the invention in various embodiments and with various modifications as are suited to the particular use contemplated. Therefore, it is intended that the invention not be limited to the particular embodiments disclosed for carrying out the invention.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention.

1. An animal entertainment apparatus comprising:
a wire element comprising a first end and a second end, wherein the second end is located at an opposing end from the first end;
a moveable base configured to move about the wire element in a first direction towards the first end and in a second directions towards the second end,
wherein the moveable base comprises an outer housing comprising at least two mating pieces, wherein the moveable base comprises a motor configured to power the moveable base to traverse the wire element.

2. The animal entertainment apparatus of claim 1, wherein the motor comprises at least one pulley wheel configured to receive the wire element.

3. The animal entertainment apparatus of claim 1, wherein a first mating piece of the at least two mating pieces includes at least one receiving aperture, and a second mating piece includes a threaded receiving element configured to receive a securing device partially extending through the at least one receiving aperture.

4. The animal entertainment apparatus of claim 3, wherein one of the at least two mating pieces comprises light-emitting diodes (LEDs).

5. The animal entertainment apparatus of claim 3, wherein one of the at least two mating pieces comprises a motor housing and at least one venting slot.

6. The animal entertainment apparatus of claim 1, further comprising a dropline device configured to extend from the moveable base, wherein the dropline device comprises an attaching lure at an opposing end from the moveable base.

7. The animal entertainment apparatus of claim 1, further comprising a remote control device configured to send commands in the form of infrared signals.

8. The animal entertainment apparatus of claim 7, wherein the moveable base comprises a receiver element configured to receive commands from the remote control device.

9. The animal entertainment apparatus of claim 8, wherein the moveable base comprises a payload configured to house the receiver element.

10. The animal entertainment apparatus of claim 8, wherein the first end of the wire element is between 10 and 20 feet from the second end of the wire element.

11. A moveable base configured to move about a wire element in a first direction towards a first end of the wire element and in a second directions towards a second end of the wire element, the moveable base comprising:
an outer housing comprising at least two mating pieces, wherein a first mating piece of the at least two mating pieces includes at least one receiving aperture, and a second mating piece includes a threaded receiving element configured to receive a securing device partially extending through the at least one receiving aperture;
a motor located within a motor housing of one of the at least two mating pieces, wherein the motor is configured to power the moveable base to traverse the wire element; and
a receiver element configured to receive commands from the remote control device.

12. The moveable base of claim 11, wherein the motor comprises at least one pulley wheel configured to receive the wire element.

13. The moveable base of claim 11, wherein one of the at least two mating pieces comprises light-emitting diodes (LEDs).

14. The moveable base of claim 11, wherein one of the at least two mating pieces comprises at least one venting slot for the motor.

15. The moveable base of claim 11, wherein the moveable base comprises a payload configured to house the receiver element.

16. The moveable base of claim 15, further comprising a dropline device configured to extend from the payload, wherein the dropline device comprises an attaching lure at an opposing end from the payload.

17. The moveable base of claim 11, wherein the receiver device is configured to receive infrared signals from the remote control device.

18. The moveable base of claim 11, wherein the first end of the wire element is between 10 and 20 feet from the second end of the wire element.
